(19) United States
(12) Patent Application Publication
(10) Pub. No.: US 2015/0131354 A1
(43) Pub. Date: May 14, 2015

(54) AC-DC CONVERTER

(71) Applicant: Kabushiki Kaisha Toshiba, Tokyo (JP)

(72) Inventors: Yuji Nakajima, Nishitama-gun (JP); Shigeyasu Iwata, Hamura-shi (JP)

(21) Appl. No.: 14/444,393

(22) Filed: Jul. 28, 2014

(30) Foreign Application Priority Data
Nov. 11, 2013 (JP) 2013-233344

(51) Int. Cl. H02M 7/00; H02M 7/04

(52) U.S. Cl. CPC H02M 7/003; H02M 7/04
USPC 363/144

(57) ABSTRACT

According to one embodiment, an AC-DC converter includes a first printed wiring board, a planar transformer, a plurality of primary members, and a plurality of secondary members. The planar transformer has a primary coil, a secondary coil, a second printed wiring board and a core. The primary members are mounted on the first printed wiring board, and are electrically connected to the primary coil. The secondary members are mounted on the second printed wiring board, and are electrically connected to the secondary coil.

### CROSS-REFERENCE TO RELATED APPLICATIONS

This application is based upon and claims the benefit of priority from Japanese Patent Application No. 2013-233344, filed Nov. 11, 2013, the entire contents of which are incorporated herein by reference.

### FIELD

Embodiments described herein relate generally to AC-DC converter altering an electric current from AC to DC.

### BACKGROUND

There is an AC-DC converter which has a planar transformer. This AC-DC converter is demanded to be miniaturized.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view illustrating an AC/DC adapter which has an AC-DC converter according to an embodiment;

FIG. 2 is an exploded perspective view of the AC/DC adapter in FIG. 1;

FIG. 3 is an exploded perspective view of the AC/DC adapter in FIG. 1 seen from a direction different from that in FIG. 2;

FIG. 4 is a perspective view illustrating an interior of the AC-DC converter in FIG. 1;

FIG. 5 is a bottom surface view of the AC-DC converter in FIG. 4;

FIG. 6 is an exploded perspective view of a second printed circuit board and an insulating member included in the AC-DC converter in FIG. 4;

FIG. 7 is a cross-sectional view along an F7-F7 line in FIG. 4;

FIG. 8 is an exploded perspective view of a planar transformer provided on the second printed circuit board in FIG. 6; and

FIG. 9 is a cross-sectional view illustrating part of the second printed wiring board in FIG. 6.

### DETAILED DESCRIPTION

An AC-DC converter which has primary members and secondary members desirably has a creepage distance between the primary members and the secondary members. Further, according to an embodiment, the AC-DC converter which can be miniaturized while securing the creepage distance is provided.

In general, according to one embodiment, an AC-DC converter includes a first printed wiring board, a planar transformer, a plurality of primary members, and a plurality of secondary members. The planar transformer has a primary coil, a secondary coil, a second printed wiring board having a plurality of layers including conductive patterns, and a core configured to be combined with the second printed wiring board. The planar transformer opposes to and is apart from the first printed wiring board. The primary members are mounted on the first printed wiring board, and are electrically connected to the primary coil. The secondary members are mounted on a plurality of layers of the second printed wiring board, and are electrically connected to the secondary coil.

Hereinafter, the embodiment will be described with reference to the drawings.

In this description, examples of a plurality of expressions are applied to some elements. In addition, the examples of these expressions are exemplary, and this is not to deny that the elements are expressed by other expressions. Further, elements to which a plurality of expressions is not applied may be expressed by other expressions.

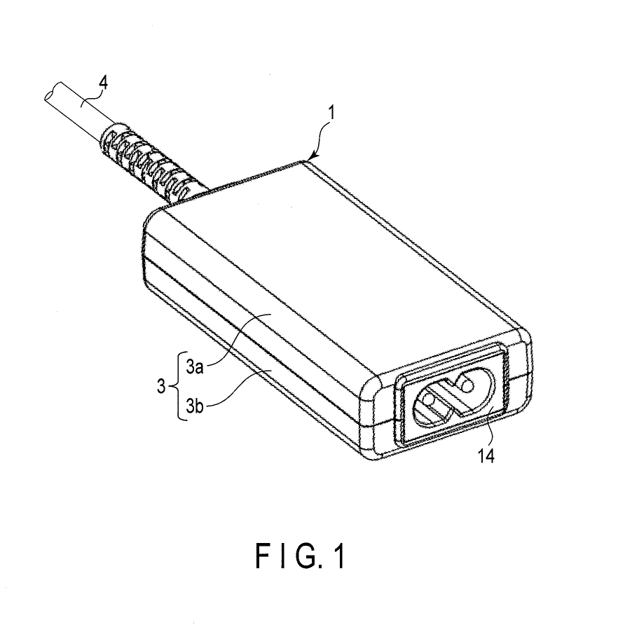

FIGS. 1 to 3 illustrate an AC/DC adapter 1 which is used as a power supply device of electronic equipment (such as a notebook portable computer (so-called notebook computer)). The AC/DC adapter 1 is formed by accommodating in a casing 3 an AC-DC converter (referred to simply as “converter” below) 11 according to the embodiment. The converter 11 has a first cooling member 5, a second cooling member 7 and a third cooling member 9.

The casing 3 has a first casing member 3a and a second casing member 3b which are molded by an electrical insulating material (such as synthetic resin), and is formed in a cuboid shape by coupling the first casing member 3a and the second casing member 3b.

The first cooling member 5, the second cooling member 7 and the third cooling member 9 are each formed by bending in a predetermined shape a metal plate of good thermal conductivity such as aluminum or copper.

The first cooling member 5 is arranged between the converter 11 and the first casing member 3a, and is thermally connected to the secondary members of the converter 11 which generate heat. The second cooling member 7 is arranged between a first printed circuit board 12 and a second printed circuit board 31 of the converter 11 described below, and is thermally connected to the primary members and the secondary members of the converter 11 which generate heat. The third cooling member 9 is arranged between the first printed circuit board 12 and the second casing member 3b, and is thermally connected to the primary members of the converter 11 which generate heat.

The first cooling member 5, the second cooling member 7 and the third cooling member 9 receive heat of electrical parts which generate significant heat among electrical parts of both of the printed circuit board, and release heat. In addition, upon the thermal connection, an insulating member is used for insulation when electrical insulation is necessary.

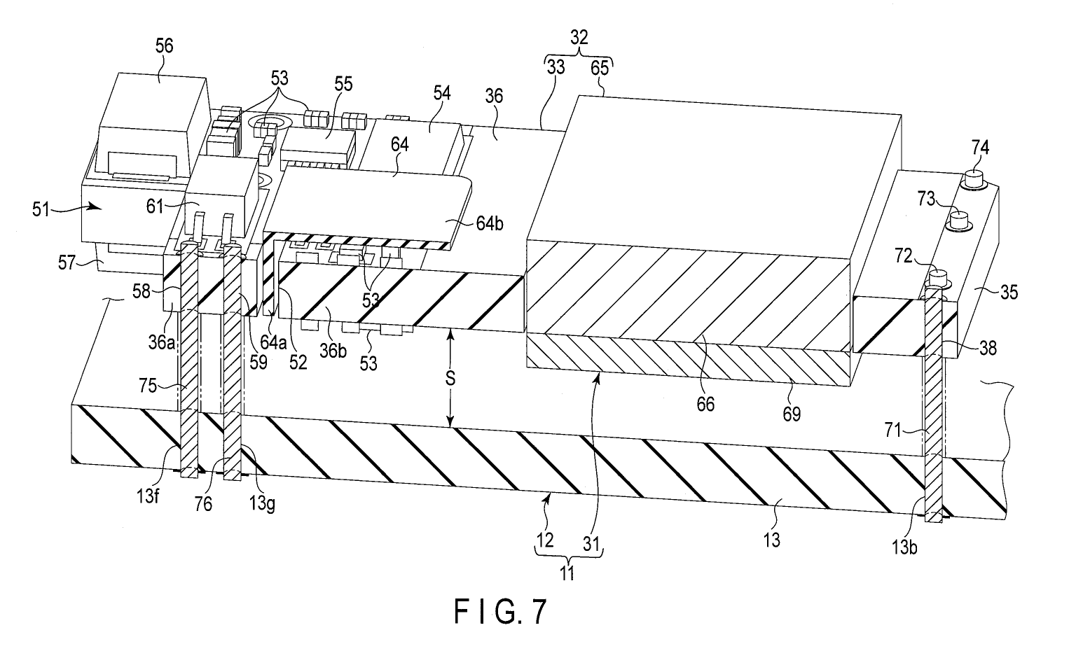

The converter 11 steps down a power voltage to be inputted to the converter 11, and outputs the power voltage. This converter 11 has the first printed circuit board 12 and the second printed circuit board 31. These first printed circuit board 12 and second printed circuit board 31 oppose to each other to overlap spaced a predetermined electrical clearance S (see FIG. 7) apart.

The first printed circuit board 12 has the first printed wiring board 13, and a plurality of primary members (that is, primary mounting parts) which is mounted on this wiring board. The primary members are electrical parts on the primary side, and are electrically connected to the primary coil of the planar transformer 32 described below.

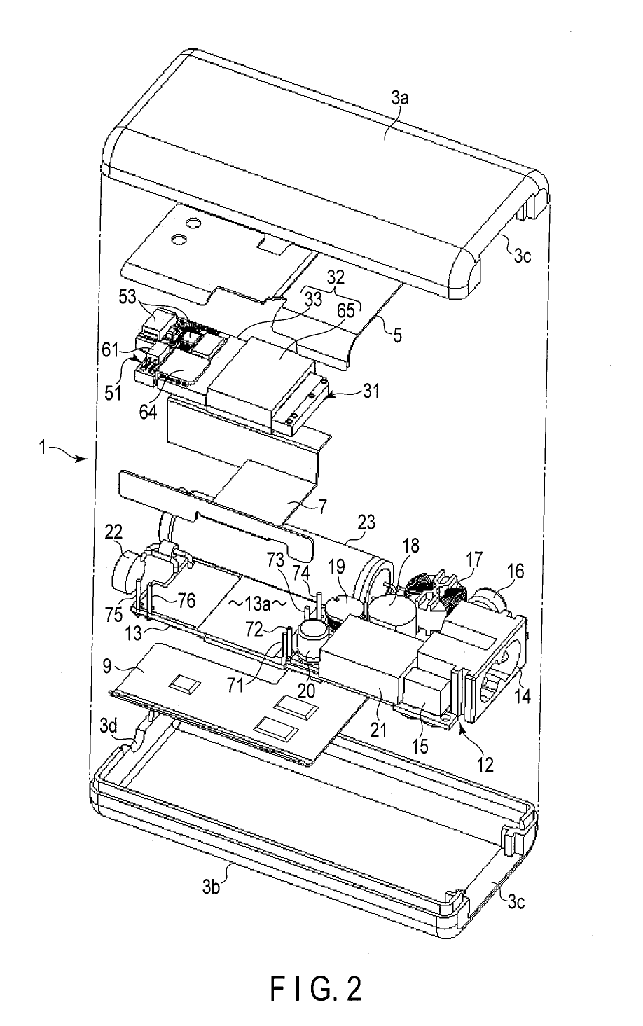

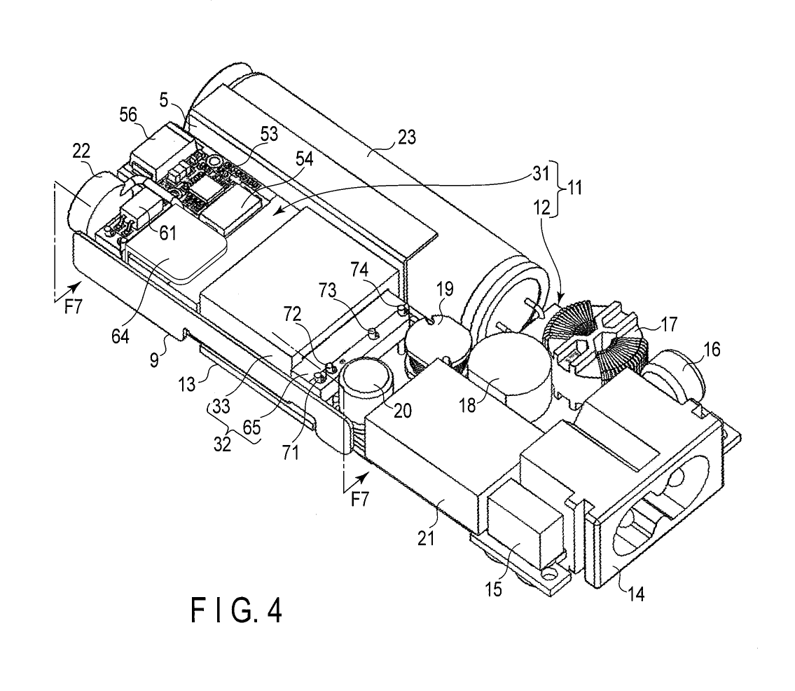

One surface (that is, an obverse) of the first printed wiring board 13 is a first surface on the second printed circuit board 31. As illustrated in FIGS. 2 and 4, a plurality of primary members mounted on the first surface includes an inlet connector 14, a current fuse 15, a thermistor 16, a choke 17, a bridge diode 18, a choke coil 19, a capacitor 20, a X-capacitor 21, a Y-capacitor 22 and an electrolytic condenser 23.

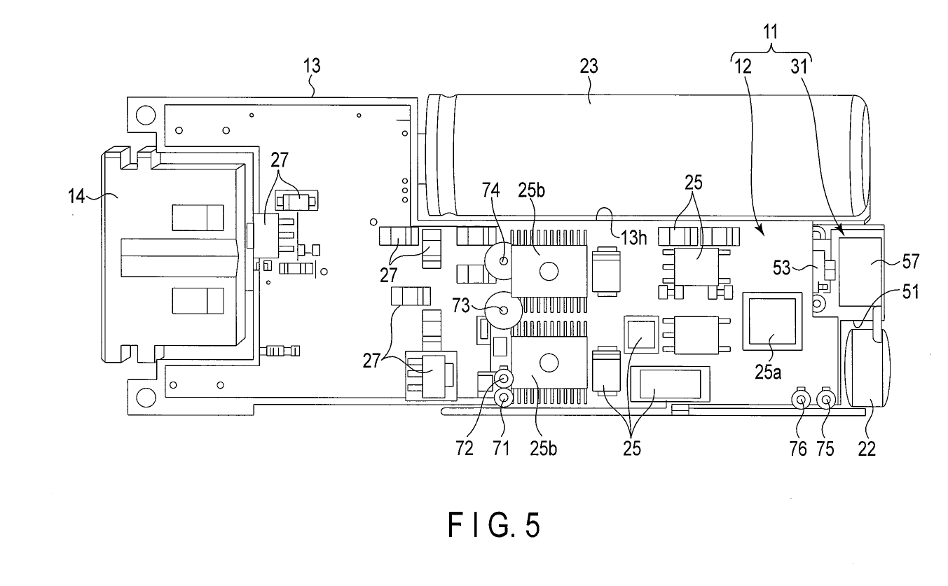

The inlet connector 14 is arranged at one end portion of the first printed wiring board 13 in the longitudinal direction. The electrolytic condenser 23 has a columnar shape, is arranged such that a center axis line of the electrolytic condenser 23 is parallel to the first printed wiring board 13 and is arranged to be accommodated in a recess 13h of a cut-out (see FIG. 5) of the first printed wiring board 13. The thickness of the converter 11 is reduced by arranging the electrolytic condenser 23 in this way.

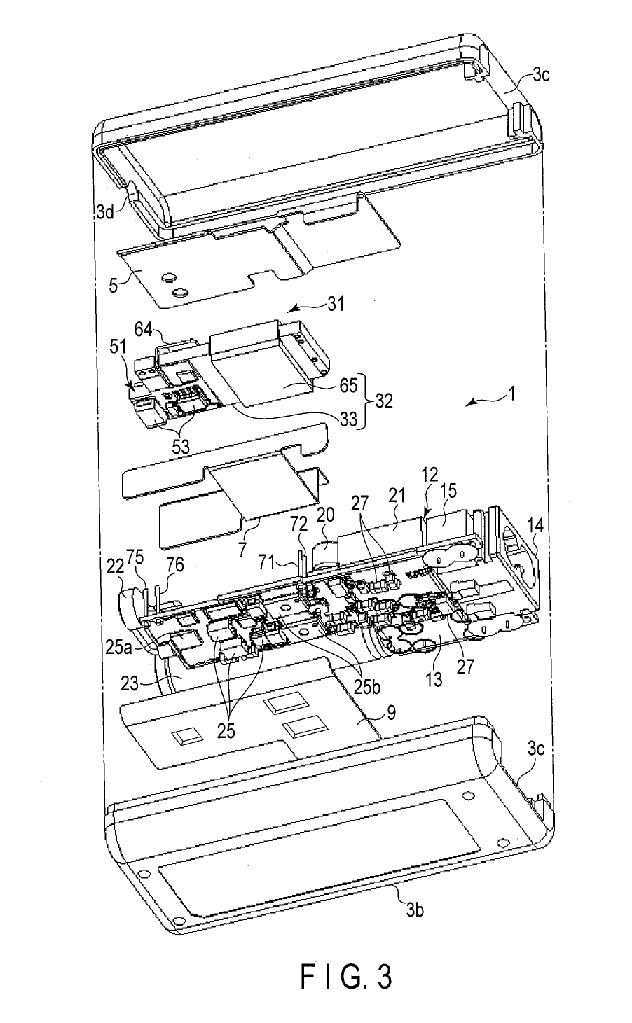

The choke 17 is a part which forms a LC circuit together with the X-capacitor 21. The Y-capacitor 22 is arranged at the other end portion of the first printed wiring board 13 in the longitudinal direction. A thickness direction of this Y-capacitor 22 is orthogonal to a thickness direction of the first printed wiring board 13. By this means, the Y-capacitor 22 is provided to have a posture which is upright from the first printed wiring board 13 toward the second printed wiring board 33 as illustrated in FIGS. 2 and 3.

As illustrated in FIG. 2, the first printed wiring board 13 has an installing area 13a for the second printed circuit board 31 at part of the first printed wiring board 13. Three sides of the installing area 13a are each surrounded by the Y-capacitor 22, the capacitor 20, the choke coil 19 aligned with the capacitor 20, and the electrolytic condenser 23.

A surface (that is, a reverse) opposite to the one surface of the first printed wiring board 13 is a second surface on the second casing member 3b side. The primary members mounted on this second surface are a plurality of first circuit parts 25 and a plurality of second circuit parts 27 as illustrated in FIGS. 3 and 5.

Each first circuit part 25 has a primary side control IC 25a and a semiconductor control element 25b such as a field-effect transistor (FET). Each first circuit part 25 is a part which forms a switching circuit (that is, a DC-DC conversion circuit). Each second circuit part 27 is a part which forms an AC-DC conversion circuit.

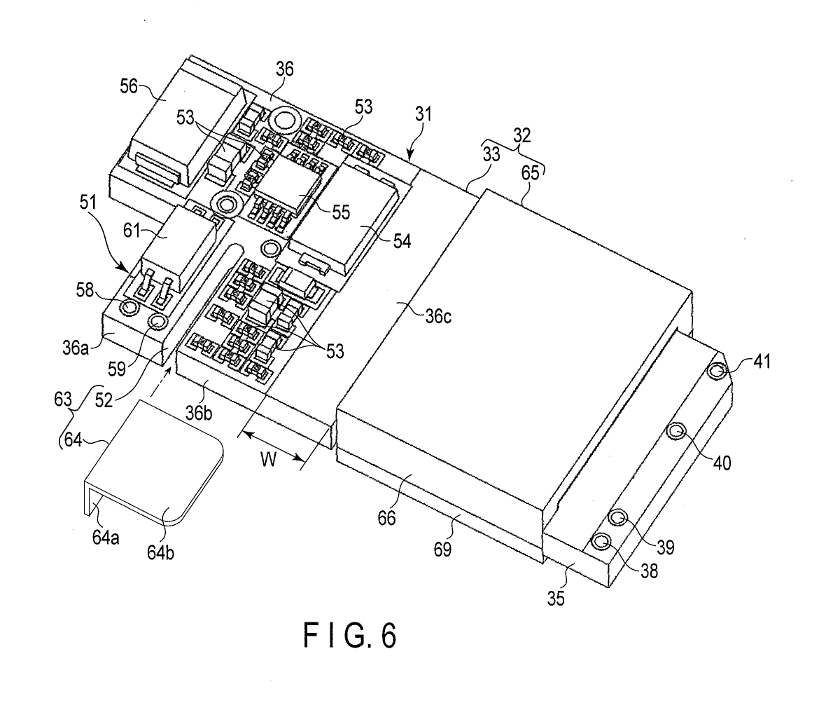

As illustrated in FIGS. 4 and 6, the second printed circuit board 31 has the planar transformer 32 and a plurality of secondary members (that is, secondary mounting parts) which is mounted on the second printed wiring board 33 of this transformer. The secondary members are electrical parts on the secondary side, and are electrically connected to a secondary coil of the planar transformer 32.

The planar transformer 32 has a primary coil, a secondary coil, the second printed wiring board 33 and a core 65.

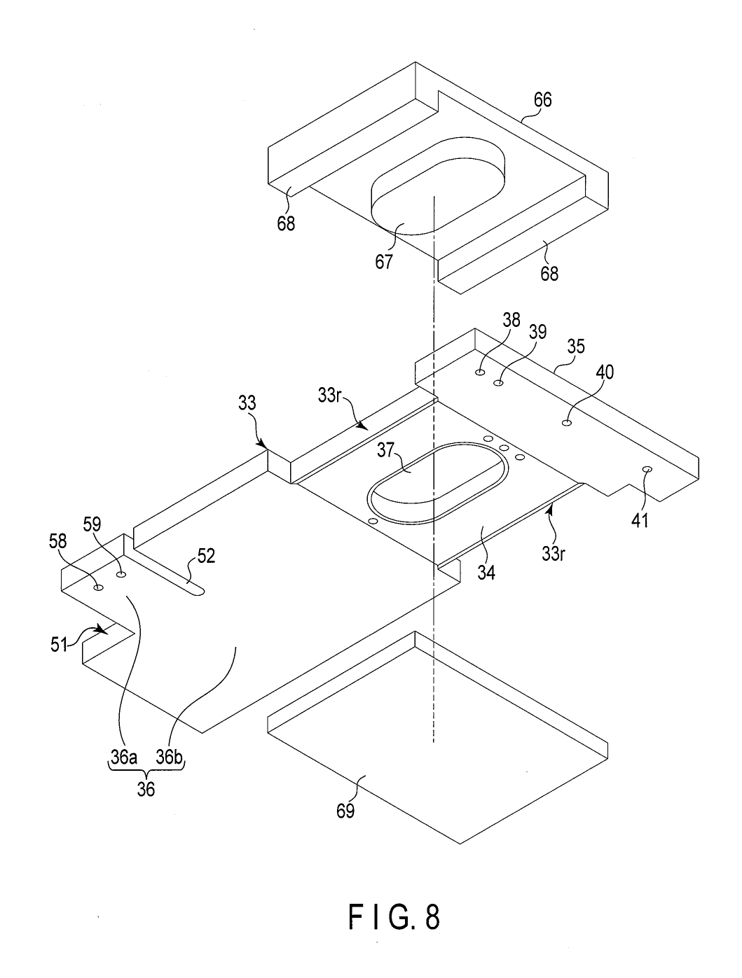

The second printed wiring board 33 is smaller than the first printed wiring board 13, and has a size corresponding to that of the installing area 13a. As illustrated in FIG. 8, the second printed wiring board 33 has a first portion 34, a second portion 35 for input and a third portion 36.

The first portion 34 has an oval or elliptical hole 37. The second portion 35 is integrated with the first portion 34, and coplanarly continues to one end of this first portion 34. This second portion 35 has a plurality of coupling holes such as a first coupling hole 38 to a fourth coupling hole 41. The third portion 36 is integrated with the first portion 34, and coplanarly continues to the other end of this first portion 34 (that is, an end opposite to the second portion 35).

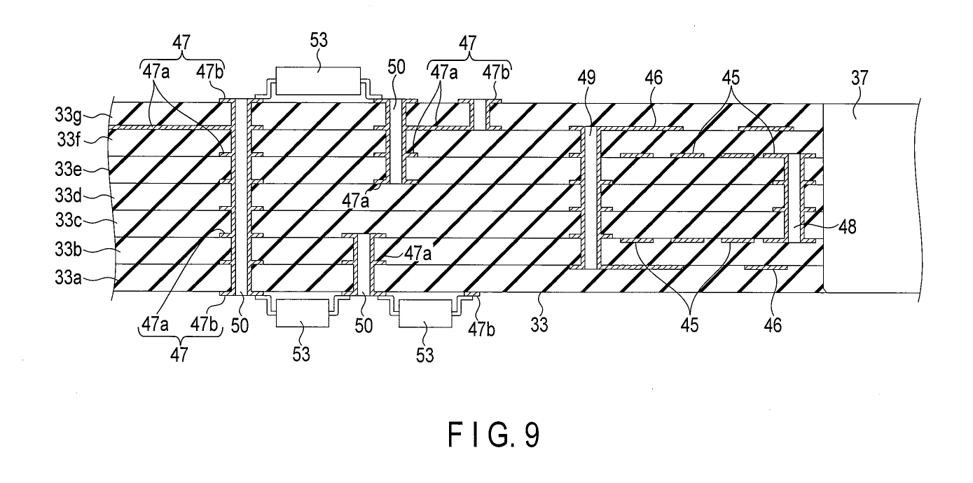

As illustrated in FIG. 9, the second printed wiring board 33 is formed by stacking a plurality of layers including first conductive patterns 45 which form the primary coil, second conductive patterns 46 which form the secondary coil and a third conductive pattern 47 which forms a secondary circuit. That is, the second printed wiring board 33 is a so-called multilayer board. Each layer of the multiplayer board is made of an electrical insulating member. The second printed wiring board 33 preferably has three layers or more. Although the second printed wiring board 33 illustrated in FIG. 9 has a first layer 33a to a seventh layer 33g, the second printed wiring board 33 is not limited thereto.

The first conductive patterns 45 and the second conductive patterns 46 have spiral shapes which surround the hole 37, and are formed inside the first portion 34.

In case of, for example, the second printed wiring board 33 illustrated in FIG. 9, the first conductive patterns 45 are provided in the second layer 33b and the fifth layer 33e, respectively. These first conductive patterns 45 are electrically connected through a first through-hole 48 stretching over the second layer 33b to the fifth layer 33e. Both ends of the first conductive patterns 45 reach the second portion 35.

Similarly, the second conductive patterns 46 are provided in the first layer 33a and the sixth layer 33f of the second printed wiring board 33, respectively. These second conductive patterns 46 are electrically connected through a second through-hole 49 stretching over the first layer 33a to the sixth layer 33f. Both ends of the second conductive patterns 46 reach the third portion 36. The widths of the second conductive patterns 46 are wider than the widths of the first conductive patterns 45. By this means, the density of a current flowing in the second conductive patterns 46 becomes small, so that it is possible to prevent heat generation in the second conductive patterns 46.

In addition, the first conductive patterns 45 and the second conductive patterns 46 may be provided in an arrangement which is reverse to the above-described arrangement. That is, inside the first portion 34, the first conductive patterns 45 which form the primary coil may also be arranged at a region closer to both surfaces than the center portion of the first portion 34, and the second conductive patterns 46 which form the secondary coil may also be arranged at the center portion of the first portion 34 (in other words, between the first conductive patterns 45).

The third conductive patterns 47 are formed in the third portion 36. The third conductive patterns 47 continue to the second conductive patterns 46 which form the secondary coil. The third conductive pattern 47 has an inner pattern portion 47a and an outer pattern portion 47b. The inner pattern portion 47a is formed inside the third portion 36. The outer pattern portion 47b is formed on an outer surface (that is, an obverse and a reverse) of the third portion 36. These inner pattern portion 47a and the outer pattern portion 47b are electrically connected through a third through-hole 50.

As illustrated in FIGS. 6 and 8, the third portion 36 of the second printed wiring board 33 has a recess 51 and a slot 52. The recess 51 is formed by being dented by cutting one corner portion of the third portion 36. The slot 52 penetrates the third portion 36 in the thickness direction, and is opened in a lateral surface of the third portion 36.

The third portion 36 has a first region 36a which is between the recess 51 and the slot 52, and the second region 36b which is an area other than this first region 36a. The lateral surface of the first region 36a opposite to the slot 52 is exposed to the recess 51. The region of the second region 36b which is adjacent to the first region 36a in the longitudinal direction of the second printed wiring board 33, and the first region 36a are separated by the slot 52. As illustrated in FIGS. 6 and 8, the first region 36a of the third portion 36 has coupling holes such as a fifth coupling hole 58 and a sixth coupling hole 59 at a front end portion of the first region 36a.

The one surface (that is, the obverse) of the third portion 36 is the first surface on the first casing member 3a side. The surface (that is, the reverse) of the third portion 36 opposite to the one surface is the second surface which opposes to the first printed circuit board 12.

The secondary members are mounted on all of a plurality of layers of the second printed wiring board 33. For example, as illustrated in FIGS. 6 to 8, a plurality of secondary members 53 is mounted on the first surface and the second surface of the third portion 36, respectively. These secondary members 53 are electrically connected with the secondary coil through the third conductive patterns 47 which form the secondary circuit. The secondary members 53 include, for example, a diode 54, a secondary side control IC 55, a first capacitor 56 and a second capacitor 57.

A photo-coupler 61 is mounted on the first region 36a. The photo-coupler 61 transmits a signal which controls the primary circuit. This photo-coupler 61 has a light emitting diode (that is, a light emitting element) and a photo-transistor (that is, a light receiving element) which photoelectrically converts light emitted from the light emitting diode. A predetermined creepage distance is secured between terminals of these elements. Light emission of the light emitting element is controlled by the secondary side control IC 55. The light receiving element of this photo-coupler 61 feeds back a signal to the first printed circuit board 12 as described below. Hence, the light receiving element of the photo-coupler 61 is included as the primary members.

Part of the secondary members 53 which are the secondary members 53 arranged on the second region 36b and which are mounted in a region adjacent to the photo-coupler 61 across the slot 52, and the photo-coupler 61 are electrically insulated by an insulating means 63. The insulating means 63 has the slot 52 and an insulating member 64.

The slot 52 separates the region of the second region 36b in which the part of the secondary members 53 are mounted, and the first region on which the photo-coupler 61 is mounted. The insulating member 64 is made of an electrical insulating material such as synthetic resin, and has an insertion portion 64a and a cover portion 64b which is bent from the insertion portion 64a. The insulating member 64 inserts the insertion portion 64a in the slot 52, and is provided by covering the part of the secondary members 53 by the cover portion 64b.

Hence, the insulating member 64 secures a creepage distance of a predetermined length between the photo-coupler 61 and the part of the secondary members 53.

In addition, the insulating means 63 may also employ a configuration where the insulating member 64 is removed and the width of the slot 52 is widen to correspond to a required creepage distance. However, the insulating means 63 which has the insulating member 64 as described above is preferable since the insulating means 63 can reduce the length of the second printed wiring board 33 when the width of the slot 52 is narrowed. Further, the insulating member 64 may have a cover portion 64b which covers the part of the secondary members 53 mounted on the obverse of the second printed wiring board 33, and another cover portion which covers the other part of the secondary members 53 mounted on the reverse of the second printed wiring board 33.

The core 65 has a first core member 66 and a second core member 69 which are both made of ferrite. The first core member 66 has an E shape, and has a center leg 67 and a pair of side legs 68 as illustrated in FIG. 8. The center leg 67 has a shape which matches the hole 37, and both end portions of this center leg 67 in the longitudinal direction are round, that is, have so-called oval shapes. The second core member 69 has an I-shape, and is a flat plate as illustrated in FIG. 8. The core 65 formed with these core members is referred to as an EIR core.

The first core member 66 is fitted to the first portion 34 from the obverse of the second printed wiring board 33. Hence, the center leg 67 is fitted in the hole 37, and the side legs 68 fit to a pair of recesses 33r of the second printed wiring board 33. The recess 33r is formed with the first portion 34, the second portion 35 and the third portion 36, and the first portion 34 is the bottom of the recess 33r. The second core member 69 is arranged in contact with the center leg 67 and the side legs 68 from the reverse of the second printed wiring board 33.

Hence, the core 65 is combined with the second printed wiring board 33 sandwiching the primary coil and the secondary coil in the first portion 34. The second portion 35 projects sideward with respect to this core 65. Similarly, the third portion 36 projects opposite to the second portion 35 with respect to the core 65.

The primary coil and the secondary coil are arranged as illustrated in FIG. 8, and the core 65 which covers the primary coil and the secondary coil is included as the primary members. Hence, the third portion 36 has a third area 36c (see FIG. 6) which secures a creepage distance between the secondary members 53 and the core 65 mounted on the third portion 36. There is no secondary member 53 on the third area 36c. A width W of the third area 36c is 4.8 mm to 6.0 mm.

In addition, when the primary coil and the secondary coil are provided in an arrangement which is reverse to the arrangement illustrated in FIG. 8, a creepage distance is not required between the secondary members 53 and the core 65. Instead, a third area which secures a creepage distance of 4.8 mm to 6.0 mm only needs to be provided between the coupling holes 38 to 41 of the second portion 35 and the core 65.

The first printed wiring board 13 and the second printed wiring board 33 of the planar transformer 32 are mechanically and electrically connected by coupling members (such as a plurality of pins) which have conductivity and, more specifically, by a first pin 71 to a sixth pin 76 made of metal.

More specifically, as illustrated in FIG. 7, one end portion of the first pin 71 is inserted in the first coupling hole 13b of the first printed wiring board 13, and is soldered to the first printed wiring board 13. The other end portion of this first pin 71 is inserted in the first coupling hole 38 of the second printed wiring board 33, and is soldered to the second printed wiring board 33. One end portion of the second pin 72 is inserted in a second coupling hole (not illustrated) of the first printed wiring board 13, and is soldered to the first printed wiring board 13. The other end portion of this second pin 72 is inserted in the second coupling hole 39 of the second printed wiring board 33, and is soldered to the second printed wiring board 33.

Similarly, one end portion of the third pin 73 is inserted in the third coupling hole (not illustrated) of the first printed wiring board 13, and is soldered to the first printed wiring board 13. The other end portion of this third pin 73 is inserted in the third coupling hole 40 of the second printed wiring board 33, and is soldered to the second printed wiring board 33. Similarly, one end portion of the fourth pin 74 is inserted in a fourth coupling hole (not illustrated) of the first printed wiring board 13, and is soldered to the first printed wiring board 13. The other end portion of this fourth pin 74 is inserted in the fourth coupling hole 41 of the second printed wiring board 33, and is soldered to the second printed wiring board 33.

Similarly, one end portion of the fifth pin 75 is inserted in the fifth coupling hole 13f of the first printed wiring board 13, and is soldered to the first printed wiring board 13. The other end portion of this fifth pin 75 is inserted in the fifth coupling hole 58 of the second printed wiring board 33, and is soldered to the second printed wiring board 33. Similarly, one end portion of the sixth pin 76 is inserted in the sixth coupling hole 13g of the first printed wiring board 13, and is soldered to the first printed wiring board 13. The other end portion of this sixth pin 76 is inserted in the sixth coupling hole 59 of the second printed wiring board 33, and is soldered to the second printed wiring board 33.

The first pin 71 to the sixth pin 76 whose both end portions are coupled to the first printed wiring board 13 and the second printed wiring board 33 extend along the thickness directions of the first printed wiring board 13 and the second printed wiring board 33 as described above. Hence, the first printed wiring board 13 and the second printed wiring board 33 of the planar transformer 32 are spaced a distance which corresponds to the lengths of the first pin 71 to the sixth pin 76 apart in the thickness directions of the first printed wiring board 13 and the second printed wiring board 33.

By this means, a predetermined electrical clearance (creepage distance) S is secured between each primary member which is mounted on the obverse of the first printed wiring board 13 and each secondary member 53 which is mounted on the reverse of the second printed wiring board 33. For example, an air gap functions to electrically insulate the first printed circuit board 12 and the second printed circuit board 31. The electrical clearance S secured by this air gap is 4.8 to 6.0 mm. However, electrical insulation is not limited to this, and the first printed circuit board 12 and the second printed circuit board 31 may be electrically insulated by interposing a sheet insulating member or the like between the first printed wiring board 13 and the second printed wiring board 33. In this case, the electrical clearance S can be 4.8 mm or less.

In addition, in the present embodiment, the first pin 71 to the sixth pin 76 are soldered in advance to the first printed wiring board 13 as illustrated in FIG. 2 as the parts to be mounted on the first printed circuit board 12. Hence, the coupling holes of the second printed wiring board 33 are fitted to the corresponding first pin 71 to sixth pin 76 prepared in the first printed circuit board 12, respectively, and then the first pin 71 to the sixth pin 76 and the second printed wiring board 33 are soldered. By this means, the first printed wiring board 13 and the second printed wiring board 33 are coupled.

However, coupling is not limited to this, and the first pin 71 to the sixth pin 76 may be soldered in advance to the second printed wiring board 33 as parts to be mounted on the second printed circuit board 31. In this case, the coupling holes of the first printed wiring board 13 are fitted to the corresponding first pin 71 to sixth pin 76 prepared in the second printed circuit board 31, respectively, and then the first pin 71 to the sixth pin 76 and the first printed wiring board 13 are soldered. By this means, the first printed wiring board 13 and the second printed wiring board 33 can be coupled.

In addition, although the first pin 71 to the sixth pin 76 adopt metal sticks whose diameters of each portion are the same according to the present embodiment, metal sticks which also function as spacers can be used instead of these metal sticks. The pins which also function as the spacers may be, for example, pins whose intermediate portions are formed bolder than both end portions. Dashed-two dotted lines in FIG. 7 are images of the pins which have these intermediate portions. When the first printed wiring board 13 and the second printed wiring board 33 are coupled using these pins, the intermediate portions which are formed bold function as the spacers. By this means, the first printed wiring board 13 and the second printed wiring board 33 are spaced apart an interval which corresponds to the length of the intermediate portion. Consequently, the predetermined electrical clearance (creepage distance) S is secured between the first printed circuit board 12 and the second printed circuit board 31. Flanges which abut on the first printed wiring board 13 and the second printed wiring board 33 may be provided instead of the intermediate portions.

In a state where the converter 11 is assembled, the Y-capacitor 22 which has the first printed circuit board 12 is accommodated in the recess 51 of the second printed wiring board 33 as illustrated in FIGS. 4 and 5. According to this configuration, arrangement vacancy of the Y-capacitor 22 is not required on the first printed wiring board 13. Consequently, it is possible to reduce the length of the first printed wiring board 13 and miniaturize the converter 11 accordingly. In addition, when the Y-capacitor 22 is overlapped on the obverse of the first printed wiring board 13 to match the thickness direction of the Y-capacitor 22 and the thickness direction of the first printed wiring board 13, the arrangement vacancy matching the area of the Y-capacitor 22 is required on the first printed wiring board 13.

The first pin 71 to the sixth pin 76 are electrically connected to a wiring pattern of the first printed wiring board 13 by way of soldering. Further, the first pin 71 and the second pin 72 are electrically connected to both end portions of the primary coil formed in the second printed wiring board 33 by the first conductive patterns 45. Similarly, the third pin 73 and the fourth pin 74 are electrically connected to both end portions of the secondary coil formed in the second printed wiring board 33 by the second conductive patters 46. Also, the fifth pin 75 and the sixth pin 76 are electrically connected to a plus terminal and a minus terminal of the light receiving element of the photo-coupler 61.

The converter 11 employing the above configuration is accommodated in the casing 3. As illustrated in FIGS. 2 and 3, the first casing member 3a and the second casing member 3b each have a first recess 3c at one end in the longitudinal directions of the first casing member 3a and the second casing member 3b. These first recesses 3c form a square hole which is opened in one end surface of the casing 3 in a state where the first casing member 3a and the second casing member 3b are combined. The inlet connector 14 of the converter 11 is fitted to this hole. A power supply connector of a power supply code (not illustrated) connected to an AC power source is detachably connected to the inlet connector 14 exposed to an outside of the casing 3.

Further, the first casing member 3a and the second casing member 3b each have a second recess 3d at the other end in the longitudinal directions of the first casing member 3a and the second casing member 3b as illustrated in FIGS. 2 and 3. These second recesses 3d form a hole which is opened in the other end surface of the casing 3 in a state where the first casing member 3a and the second casing member 3b are combined. The cord 4 illustrated in FIG. 1 is inserted in this hole. One end of the cord 4 is connected to an output unit of the second printed circuit board 31 in the casing 3. The other end of the cord 4 is detachably connected to electronic equipment such as a notebook PC.

Power of AC 100 V inputted to the inlet connector 14 is limited by the current fuse 15 to prevent an overcurrent from flowing to the converter 11, and is limited by the thermistor 16 to prevent an excessive inrush current from flowing to the converter 11. Subsequently, a LC circuit (that is, a noise filter) which is formed with the choke 17 and the X-capacitor 21 cuts noise components superimposed on input power. Next, the input power is rectified (that is, converted into a direct current) by a bridge circuit which has the bridge diode 18, and is divided into plus and minus rectification outputs.

After the noise components are canceled from the rectification outputs by the choke coil 19, the rectification outputs are supplied to the electrolytic condenser 23 through the capacitor 20. The electrolytic condenser 23 smoothes the rectification outputs. Subsequently, the smoothed input is converted into a high frequency wave by a switching circuit formed by each first circuit part 25. In this case, the primary side control IC 25a which generates a high frequency wave is controlled by the control element 25b. The high frequency wave generated in this way is supplied to the planar transformer 32 of the second printed circuit board 31 through the first pin 71 to the fourth pin 74.

The planar transformer 32 steps down the voltage from, for example, 100 V to 19 V. The output of the planar transformer 32 is rectified by the diode 54, and is divided into plus and minus outputs. Subsequently, the rectification output of the diode 54 is smoothed by the first capacitor 56 and the second capacitor 57. This smoothed direct current is supplied to, for example, a load (notebook PC) through the cord 4.

The secondary side control IC 55 of the second printed circuit board 31 detects a power consumption amount of the load based on the current amount, and determines whether or not it is necessary to save power of the load. When it is determined that it is necessary to save power, the secondary side control IC 55 controls transmission and reception of an optical signal between the light emitting element and the light receiving element of the photo-coupler 61. As a result, the signal to be outputted from the light receiving element of the photo-coupler 61 is fed back to the first printed circuit board 12 through the fifth pin 75 and the sixth pin 76. This feedback signal is supplied to the secondary side control IC 55. Hence, a switching operation of the switching circuit is controlled to reduce power. In addition, the Y-capacitor 22 cuts noise to be superimposed by the output side (load side) of the converter 11.

The converter 11 has two printed wiring boards instead of a single printed wiring board, that is, the first printed wiring board 13 and the second printed wiring board 33. These first printed wiring board 13 and second printed wiring board 33 are spaced apart the electrical clearance S which is provided between the primary members and the secondary members mounted on the first printed wiring board 13 and the second printed wiring board 33. Consequently, it is possible to make planar shapes of the first printed wiring board 13 and the second printed wiring board 33 smaller and miniaturize the converter 11.

In addition, the planar transformer 32 which has the second printed wiring board 33 formed with a multilayer substrate is thin. By this means, it is also possible to prevent the thickness of the converter 11, that is, the thickness in a direction in which the first printed wiring board 13 and the second printed wiring board 33 are spaced apart from increasing.

Further, the second printed wiring board 33 is one of parts of the planar transformer 32. All of the secondary members 53 to be connected to the secondary side of this planar transformer 32 are mounted on the third portion 33c of the second printed wiring board 33. By this means, at least part of the secondary members 53 and the primary members to be connected to the primary side of the planar transformer 32 are not arranged on the first printed wiring board 13.

When the primary members and the secondary members are arranged on the same printed wiring board, these primary members and secondary members need to be spaced a creepage distance apart. The planar shapes of the printed wiring boards including vacancy corresponding to the creepage distance are large. By contrast with this, in the converter 11 according to the present embodiment, there is no secondary member 53 on the first printed wiring board 13. Consequently, it is possible to make smaller the planar shape (area) of the first printed wiring board 13 which does not require vacancy for the creepage distance. Consequently, it is possible to miniaturize the converter 11, decrease a volume which the converter 11 occupies in the casing 3 of the AC/DC adapter 1, and miniaturize and reduce the weight of the AC/DC adapter 1.

Further, all secondary members 53 are arranged using the second printed wiring board 33 of the planar transformer 32. That is, all secondary members 53 are arranged on the third portion 36 of the second printed wiring board 33 which projects to an outside of the core 65. The second printed wiring board 33 is formed with a multiplayer substrate, so that an arrangement of the third conductive pattern 47 is highly dense and a packaging density (mounting density) of the secondary members 53 is also high. Consequently, it is possible to make the planar shape of the second printed wiring board 33 smaller. As a result, the installing area 13a for the second printed wiring board 33 on the first printed wiring board 13 is small, so that it is possible to make the planar shape of the first printed wiring board 13 smaller. Consequently, it is possible to miniaturize and reduce the weight of the converter 11 and the AC/DC adapter.

Moreover, the current whose voltage becomes low by being stepped down flows to each secondary member 53, and a withstand voltage is low, so that the volume of each secondary member 53 becomes small. Meanwhile, the volume of each secondary member 53 is about ⅓ compared to an average volume of each primary member mounted on the first printed wiring board 13. Consequently, the area of the third portion 36 is small and, further, an occupied area of the second printed wiring board 33 with respect to the first printed wiring board 13 becomes small. Accordingly, the size of the first printed wiring board 13 becomes smaller, so that it is possible to miniaturize and reduce the weight of the converter 11 and the AC/DC adapter 1.

In addition, the second printed wiring board 33 requires the third area 36c which secures a creepage distance between the secondary members 53 and the core 65. However, an effect of miniaturizing the second printed wiring board 33 for the above-described reason is great, so that it is possible to make the size of the second printed wiring board 33 smaller irrespectively of the existence of the third area 36c.

Consequently, according to the present embodiment, it is possible to miniaturize the converter 11 while securing the creepage distance and, consequently, reduce the weight of the converter 11 for the above-described reason. Consequently, it is also possible to miniaturize and reduce the weight of the AC/DC adapter 1 in which the converter 11 is built in.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An AC-DC converter comprising:
a first printed wiring board;
a planar transformer comprising
a primary coil;
a secondary coil;
a second printed wiring board comprising a plurality of layers comprising conductive patterns, and
a core configured to be combined with the second printed wiring board, the planar transformer opposing and apart from the first printed wiring board;
a plurality of primary members on the first printed wiring board and configured to be electrically connected to the primary coil; and
a plurality of secondary members on the plurality of layers of the second printed wiring board, configured to be electrically connected to the secondary coil.

2. The AC-DC converter of claim 1, further comprising:
a plurality of pins with conductivity, configured to couple the first printed wiring board and the second printed wiring board with a gap therebetween by soldering one end of each of the pins to the first printed wiring board and the other end of each of the pins to the second printed wiring board.

3. The AC-DC converter of claim 1, wherein
the conductive patterns comprise a first conductive pattern configured to form the primary coil, a second conductive pattern configured to form the secondary coil and a third conductive pattern configured to form a secondary circuit by connecting to the second conductive pattern,
the core is arranged according to the first conductive pattern and the second conductive pattern, and
the secondary members are each connected to the third conductive pattern.

4. The AC-DC converter of claim 3, wherein
the second printed wiring board comprises
a first portion comprising the first conductive pattern and the second conductive pattern,
a second portion configured to be placed outside the core integrally extending to the first portion so as to reach the both ends of the first conductive pattern, the second portion configured to be electrically connected to the first printed wiring board through the pins, and
a third portion which configured to be placed outside the core integrally extending to the first portion from an opposite side corresponding to the second portion, the third portion comprising the third conductive pattern.

5. The AC-DC converter of claim 4, wherein
the third portion comprises a first region and a second region, and
the primary member comprises a photo-coupler in the first region, wherein the photo-coupler is electrically insulated from a part of adjacent secondary members of the secondary members arranged in the second region.

6. The AC-DC converter of claim 5, wherein
the second printed wiring board comprises:
a slot configured to separate a portion of the second region on which the part of the secondary members is mounted, and the first region, and
an insulating member configured to be inserted in the slot, to cover the part of the secondary members, and to insulate the part of the secondary member from the photo-coupler.

7. The AC-DC converter of claim 6, wherein
the second printed wiring board comprises a recess configured to expose a lateral surface of the first region opposite to the slot, and
the primary member comprises a Y-capacitor configured to be perpendicular to the first printed wiring board toward the second printed wiring board in the recess.
